(19) United States
(12) Patent Application Publication
(10) Pub. No.: US 2016/0140611 A1
(43) Pub. Date: May 19, 2016

(54) SYSTEM AND METHOD FOR CRITERIA-BASED ADVERTISEMENT BLOCKING

(71) Applicant: Sizmek Technologies Ltd., Herzliya (IL)

(72) Inventors: Jonathan SCHLER, Petach Tikwa (IL); Kobi SHEMER, Netanya (IL)

(73) Assignee: Sizmek Technologies Ltd., Herzliya (IL)

(21) Appl. No.: 15/005,616

(22) Filed: Jan. 25, 2016

Related U.S. Application Data
(63) Continuation-in-part of application No. 12/973,541, filed on Dec. 20, 2010.

(51) Int. Cl. G06Q 30/02

(52) U.S. Cl. CPC G06Q 30/0257; G06Q 30/0277

(57) ABSTRACT

A method and system for criteria-based advertisement blocking are presented. The method comprises receiving blocking criteria of an advertisement to be displayed in a web page and information identifying the web page; analyzing the identifying information to determine at least one blocking factor associated with the web page, wherein the identifying information includes at least a uniform resource locator (URL) of the web page; determining, based on the at least one blocking factor, whether the blocking criteria have been met; and automatically blocking a display of the advertisement in the web page, when the blocking criteria have been met.

### CROSS-REFERENCE TO RELATED APPLICATIONS

This application is a continuation-in-part (CIP) of U.S. patent application Ser. No. 12/973,541 filed on Dec. 20, 2010, now pending, which is hereby incorporated by reference for all that it contains.

### TECHNICAL FIELD

The present disclosure relates generally to delivering advertisements via web pages, and more specifically to blocking advertisements based on content in web pages.

### BACKGROUND

Various systems and methods for advertising over the internet exist today. In modern systems, rather than incorporating advertisements into webpages at the website, advertisements are typically dynamically associated with web pages according to various rules, conditions or circumstances. For example, advertisements may be dynamically placed in webpages provided to a user based on a user profile, a time of day, a campaign or any other criteria, rules, or logic.

Real time bidding (RTB) is designed to provide an exchange-like, online, real-time market for advertising in webpages. Generally, webpages may have spots or place holders reserved for advertisements and an auction for placing an advertisement in a webpage (or a spot) may be held, enabling advertisers to place bids for advertising in the webpage or spot. The real-time aspect of the RTB is related to the fact that an auction for advertising in the webpage may be held immediately before, or even when, the page is provided to the user. Accordingly, although RTB enables many desirable features to both advertisers and publishers, it also presents a number of problems.

For example, since the process of selecting an advertisement is performed in real time, it has to be fast in order for the advertisement to be displayed when the webpage is displayed to a user or not long thereafter. Another problem may be related to the information available to a bidder. For example, a bidder may improve his bidding decisions based on any relevant information, e.g., the website from which the webpage is provided and/or content in the webpage may be highly valuable information when determining whether or how to bid for a spot in a webpage.

Existing solutions for delivering advertisements based on RTB also frequently deliver advertisements to users along with content that is inappropriate for that advertisement. These inappropriate advertisements may harm, rather than improve, a company's reputation because a consumer may associate the advertisement with the inappropriate content. As an example, an advertisement for a new car may be placed in a web page including a news article related to a car crash. As another example, an advertisement for a children's video game may be placed in a web page including information related to a violent video game.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Some exemplary embodiments disclosed herein includes a method for criteria-based advertisement blocking. The method comprises receiving blocking criteria of an advertisement to be displayed in a web page and information identifying the web page; analyzing the identifying information to determine at least one blocking factor associated with the web page, wherein the identifying information includes at least a uniform resource locator (URL) of the web page; determining, based on the at least one blocking factor, whether the blocking criteria have been met; and automatically blocking a display of the advertisement in the web page, when the blocking criteria have been met.

Some exemplary embodiments disclosed herein includes a system for criteria-based advertisement blocking. The system comprises processing unit; and a memory, the memory containing instructions that, when executed by the processing unit, configure the system to: receive blocking criteria of an advertisement to be displayed in a web page and information identifying the web page; analyze the identifying information to determine at least one blocking factor associated with the web page, wherein the identifying information includes at least a uniform resource locator (URL) of the web page; determine, based on the at least one blocking factor, whether the blocking criteria have been met; and automatically block a display of the advertisement in the web page, when the blocking criteria have been met.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a classifier unit according to an embodiment.

FIG. 3 is a flowchart illustrating a method for blocking advertisements based on web page content according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

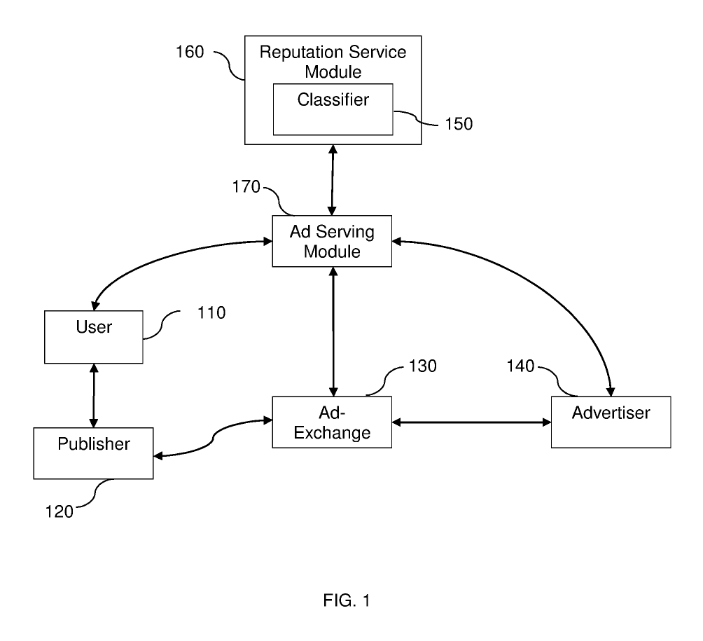

FIG. 1 shows an exemplary and non-limiting block diagram utilized to describe the various disclosed embodiments. The block diagram includes a user device 110, a publisher server 120, an ad-exchange 130, an advertiser device 140, a reputation service module 160 including a classifier 150, and an advertisement serving module 170.

The exchange 130 may be communicatively connected to the publisher server 120 and to the advertiser device 140. The exchange 130 may receive a request for an advertisement to be displayed on a web page including an address (e.g., a URL) of the web page. The exchange may conduct a bidding process to determine which advertiser (e.g., an advertiser of the advertiser device 140) to retrieve an advertisement from. The ad-exchange 130 may send a request for an advertisement to the advertisement serving module 170 including the address of the web page.

The advertising serving module 170 may receive the request for an advertisement for display on a web page from the publisher server 120, send blocking criteria and information related to the web page to the reputation service module 160 for analysis, and withhold placement of the advertisement in the web page upon determination by the reputation service module 160 that the blocking criteria have been met. In another embodiment, the reputation service module 160 may be configured to cause the advertisement serving module 170 to provide a default advertisement for display in the web page if the blocking criteria have been met.

In yet another embodiment, the reputation service module 160 may be configured to cause the advertisement serving module 170 to pass the impression back to the publisher server 120 for redistribution if the blocking criteria have been met. The redistribution ensures that the advertisement is ultimately provided to a different web page in which it will be appropriate. As an example, an advertisement for a prescription medication may be blocked from appearing on a web page featuring an article criticizing the pharmaceutical industry and redistributed such that it is provided on a web page featuring an article on disease treatments.

The advertisement serving module 170 may be configured to receive any of the blocking criteria as inputs from an advertiser associated with the advertiser device 140. The inputs may be received via, e.g., a user interface of the advertiser device 140. As an example, an advertiser may define the blocking criteria via a graphical user interface displayed on his or her computer.

The blocking criteria may include, but are not limited to, categories of web pages and/or web sites, tolerance score thresholds, an advertisement quantity threshold, and a required language of the web page. The blocking criteria typically defines negative content, i.e., web page content that is inappropriate for a particular advertisement. As a non-limiting example, categories that are often associated with negative content for children's toy advertisements include, but are not limited to, drugs, mature, terror, accidents, disasters, and so on. As another non-limiting example, a French language advertisement may be inappropriate for a web page featuring an article written in Japanese.

The blocking criteria that are desirable for a particular advertisement may differ on the subject matter of the advertisement. For example, an advertisement for vacations may be inappropriate for web pages categorized as disasters but not for web pages categorized as mature. Further, the blocking criteria may be further based on different granularities. As an example, the blocking criteria for a car advertisement may indicate that content related to car accidents is inappropriate for the car advertisement but content related to other types of accidents (e.g., sports injuries) is not negative content.

The advertising serving module 170 is configured to send the blocking criteria and/or information related to the web page on which the advertisement will be displayed to the reputation service module 160. The reputation service module 160 is configured to analyze the web page, in real-time, and may be further configured to cache results of the analysis for future advertisements. The reputation service module 160 may be configured to determine whether the web page contains negative content based on the blocking criteria. If the blocking criteria are met, it may be determined that the web page contains negative content for the advertisement.

In an embodiment, the reputation service module 160 is also configured to analyze the web page and determine blocking factors (e.g., content categories, advertiser preferences, and so on) associated with the web page via the classifier 150. The analysis may include, but is not limited to, analyzing a domain hosting the web page, analyzing information in a uniform resource locator (URL) of the web page (e.g., a string of characters in the URL), analyzing the content in the web page (e.g., textual analysis of text in the web page, visual analysis of an image or video in the web page, audio analysis of a video or audio in the web page, etc.), combinations thereof, and so on.

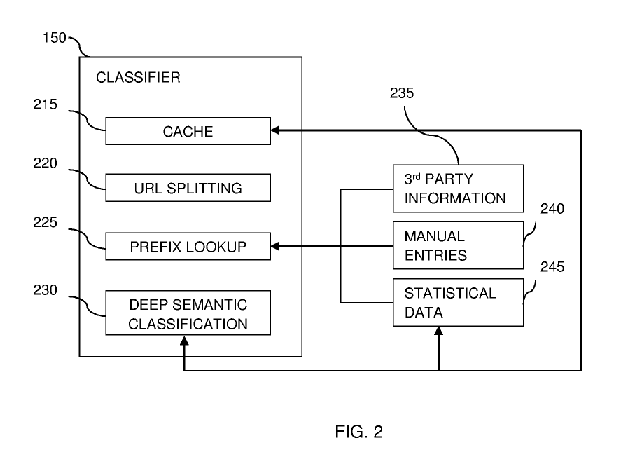

In an embodiment, the reputation service module 160 may be configured to analyze the domain hosting the web page and/or of the URL of the web page only if no content is available for analysis. In another embodiment, the reputation service module 160 may be configured to determine a statistical category probability respective of each determined category based on the analysis. The statistical category probability may indicate a likelihood that the determined category is accurate. As an example, a web page hosted on a domain known for frequently posting drug-related content may result in a drug category determination with a score of 75%. An exemplary and non-limiting classifier unit is described further herein below with respect to FIG. 2.

Based on the analysis, it may be determined whether the blocking criteria have been met and, consequently, whether the web page contains negative content respective of the advertisement. Determining whether the blocking criteria have been met may include, but is not limited to, comparing the results of the analysis to the blocking criteria to check if the analysis results categories match the blocking criteria categories, comparing tolerance scores for each category and/or for each advertiser to a tolerance score threshold, determining whether the language of the advertisement matches the language of the web page, determining whether a number of advertisements that will be displayed on the web page is above the advertisement quantity threshold, and so on.

In an embodiment, the components of FIG. 1 may be communicatively connected via a network (not shown). The network may be, but is not limited to, a wireless, cellular or wired network, a local area network (LAN), a wide area network (WAN), a metro area network (MAN), the Internet, the worldwide web (WWW), similar networks, and any combination thereof.

The user device 110 may be, but is not limited to, a personal computer, a laptop, a tablet computer, a smartphone, a wearable computing device, or any other device equipped with web browsing capabilities. The advertisements provided to the user device 110 may be displayed in or as overlays on web pages, applications, and so on. An application executed or accessed through the user device 110 may be, but is not limited to, a mobile application, a virtual application, a web application, a native application, and the like.

The reputation service module 160 typically includes a processing unit (not shown) coupled to a memory (not shown). The processing unit may comprise or be a component of a processor (not shown) or an array of processors coupled to the memory. The memory contains instructions that can be executed by the processing unit. The instructions, when executed by the processing unit, cause the processing unit to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing unit may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

It should be noted that the embodiments disclosed herein are described with respect to one publisher server 120, one advertiser device 140, and one user device 110 merely for simplicity purposes and without limitations on the disclosed embodiments. Multiple publisher, advertiser, and/or user devices may be utilized without departing from the scope of the disclosure.

It should be further noted that the embodiments described herein are not limited to the specific architecture disclosed and that other architectures may be utilized without departing from the disclosure. Specifically, the classifier 150 may be an external component of the reputation service module 160 without departing from the scope of the disclosure. Further, the classifier 150 may comprise or be a component of a system including a processing unit (not shown) coupled to a memory (not shown), where the memory contains instructions that, when executed by the processing unit, configure the classifier 150 to analyze and categorize web pages in accordance with the disclosure.

FIG. 2 is an exemplary and non-limiting schematic diagram of the classifier 150 according to an embodiment. The classifier 150 may include a cache unit 215, a URL splitting unit 220, a prefix lookup unit 225, and a deep semantic classification unit 230. As further shown, the classifier 150 may include or be operatively connected to a third (3^{rd}) party information repository 235, a manual entry repository 240, and a statistical data unit 245. In an exemplary embodiment or implementation, a request for advertisement may be processed by the classifier 150 from top to bottom, e.g., starting at the top with the cache 215 and possibly (e.g., if no cache hit in the cache 215 is made) continuing to the URL splitting unit 220, then possibly prefix lookup 225 and, e.g., if none of the above yield an acceptable result, the deep semantic classification 230, as described herein, and other sequences of processing a URL by the classifier 150 are possible.

In some embodiments, results produced by two or more units of classifier 150 may be combined or otherwise commonly used in order to produce output. For example, results produced by the cache 215, the URL splitting 220 unit, the prefix lookup 225 unit, the deep semantic classification unit 230; and/or any one of the 3^{rd} party information unit 235, the manual entry module 240, and the statistical data unit 245 may be combined. For example, results produced by the URL splitting 220 unit and/or the prefix lookup 225 unit may be examined and a result that may be a combination of such results may be produced and provided to a client as described herein. For example, the URL splitting 220 unit may associate a URL with a first classification parameter as described herein and the prefix lookup 225 unit may associate the same URL with a second classification parameter as described herein.

In some embodiments, a client may be provided with both classification parameters, in other embodiments or configurations, one of the classification parameters may be selected (based on any suitable algorithm, method or process) and provided to a client. A classification parameter may be a class, category, group, or any other parameter that may classify or categorize a URL as further described herein. Accordingly, associating a URL with a classification parameter may be referred to herein as classifying a URL, associating a URL with a class, categorizing a URL, etc. It will be understood that any reference to classifying or categorizing a URL made herein may be or may comprise associating a URL with one or more classification parameters.

In some embodiments, faster components of the classifier 150 may produce less accurate results and slower units, or units that may take longer to process a request and produce a classification may produce more accurate results. For example, the cache 215 may be very fast in terms of receiving a URL and returning a classification or classification parameter, however, cache misses may occur, and as a result, no classification (or classification parameter) may be produced by the cache 215 for some requests. In addition, entries in the cache 215 may be associated with a lower granularity than the granularity that may be achieved by the URL splitting unit 220 and/or the prefix lookup unit 225.

For example, the cache 215 may return the same classification parameter, category or classification for all webpages associated with a give web site while the URL splitting unit 220 may associate different pages from the given site with different categories. Similarly, given a request, the URL splitting unit 220 may produce a classification faster than the prefix lookup 225 unit, however, a classification parameter provided by the prefix lookup 225 unit may be more accurate or based on a finer granularity. Accordingly, a request may be processed in sequence starting with the fastest unit or entity of the classifier 150 and continuing with slower units until a classification parameter is produced. For example, starting with the cache 215, a classification of a URL may be produced very fast since, as known in the art, cache techniques and systems may be very fast. If a classification parameter for a URL is not produced by the cache 215, the URL splitting unit 220 may be provided with the URL and any other relevant parameters and may be activated. Next, if a classification parameter is produced by the URL splitting unit 220, then the classification (or a relevant parameter or index) may be provided to a client and a subsequent request may be processed (e.g., starting again with the cache 215). Alternatively, if the URL splitting unit 220 fails to produce a classification parameter, then the prefix lookup unit 225 may be caused to process the URL. Accordingly, the classifier 150 may produce a result using the fastest unit possible.

In other embodiments, processing a request may be according to another order. For example, the cache unit 215, the URL splitting unit 220, the prefix lookup unit 225 and a deep semantic classification unit 230 may be made to process a request concurrently, simultaneously or in parallel. A time constraint may be set (e.g., by arming a timer), and upon an expiration of time, the units may all be checked to determine whether they produced a result, e.g., a classification parameter or categorization of a webpage (or URL) associated with the request. As described herein, faster units may produce less accurate results, categorizations, classification parameters, or classifications, accordingly, by allowing all units to operate in parallel, the likelihood of producing at least one result may be high and further, the most accurate result possible under the time constraint may be produced. For example, if the cache 215 produces a result in less than 1 millisecond and the URL splitting unit 220 requires 3 milliseconds to produce a result, then, if it is determined that providing a classification of a URL within 5 milliseconds is acceptable, it may be desirable to allow both cache 215 and the URL splitting unit 220 to process a request for 5 milliseconds and then check both for a result. Next, if the URL splitting unit 220 produced a result, then such result may be selected as it may be more accurate than a result produced by the cache 215. If the URL splitting unit 220 failed to produce a result, then a result produced by the cache 215 may be selected.

It will be understood that the classifier 150 and associated units (e.g., the cache unit 215, the URL splitting unit 220, the prefix lookup unit 225, the deep semantic classification unit 230, the third party information 235, the manual entries 240, and the statistical data unit 245) as shown in FIG. 2 and described herein is one exemplary embodiment selected from a number of possible embodiments. In one embodiment, the classifier 150 and at least some of the connected and/or included components may be implemented as an appliance that may be placed in a suitable location, e.g., in a datacenter and/or close to (or even embedded in) an exchange described herein. In other embodiments, modules or units may be combined, e.g., the URL splitting 220 and the prefix lookup 225 may be combined into a single module. Likewise, the modules and the units shown may be divided into sub-modules or units. According to various embodiments of the disclosure, classifier 150 and/or associated units such as the cache unit 215, the URL splitting unit 220, the prefix lookup unit 225, the deep semantic classification unit 230, the third party information 235, the manual entries 240, and the statistical data unit 245 may be, may include, and/or may be implemented using hardware, software, firmware, and/or any combination thereof. According to various embodiments, the any, some, or all of the units in classifier 150 can be implemented as a processing unit discussed in detail above. For example, the cache 215 may be a dedicated hardware module installed in a computing device, the URL splitting unit 220 may be a chip and dedicated firmware operatively connected to a computing device (e.g., using an add-on card), and the prefix lookup unit 225 may be a software module.

Generally, the classifier 150 may receive a request for an advertisement (that may be generated in order to populate a spot in a webpage as described herein) and may return a classification parameter for a URL (and/or a webpage) associated with the received request. For example, a request for an advertisement may be received in association with a URL, where the URL may be related to the webpage for which the advertisement is requested. Classifier 150 may analyze the URL and return a categorization or classification parameter related to the URL and/or the associated webpage. A classification or categorization parameter (and possibly accompanied by an associated URL and various parameters related to the spot to be filled with an advertisement) may be provided to any applicable client or destination. For example, an advertiser wishing to bid for displaying advertisements may be provided with categorizing or classifying parameters that may be used by such potential bidder in order to decide whether to bid for placing his advertisement in a given webpage.

For example, an advertiser that may be interested in selling camping equipment may wish to bid for advertising in webpages related to scenic trips, nature resorts and the like, but would rather not bid (and pay for) advertising in webpages related to arcade games. Accordingly, provided with a classification of a webpage by an embodiment of the invention, such advertiser may avoid paying for displaying his advertisements in webpages where his advertisements are unlikely to be effective (e.g., displayed to irrelevant user) and only bid for displaying advertisements in relevant webpages.

Since the disclosed embodiments may provide a classification parameter related to advertising in a webpage in real-time, decisions made by clients (such as advertisers, an exchange or an entity monitoring online trends) may likewise be made in real-time. For example, an advertiser may place a bid and/or determine a price to be offered for advertising in a webpage at a time the webpage is already being served or provided to a user surfing the internet. Similarly, an exchange provided with output of the classifier 150 may determine a price for displaying an advertisement in a webpage at a time the webpage is already rendered on a display of a user's home computer, laptop, or wireless communication device.

The third party information 235 may be or may comprise a storage system or device where classification information related to domains, subdomains or page level information may be stored. For example, classification or categorization information from commercial or non-commercial bodies such as Alexa, DMOZ, or the Internet Architecture Board (IAB) standard may be collected and sites, URLs, or even specific, discrete webpages may be associated with a classification parameter based on such information or sources. Information in the third party information module 235 may be used to populate entries in prefix lookup 225. For example, simply described, prefix lookup 225 may include a list of entries in which each entry includes at least a classified object (e.g., a site, a URL, a part (e.g., a prefix) of a URL, one or more URL's prefixes, a domain or a subdomain, etc.) and a classification parameter associated with the classified object. For example, an object may be “cnn.com” (that may be a prefix of a number of URLs) and an associated classification or categorization may “American news”; likewise, the object “sportsillustrated.cnn.com” may be classified as “Sports”; sportsillustrated.cnn.com/football may be classified as “Sports/Football”; and “*.facebook.com” may be classified as “Internet/SocialNetworks”. As used herein, a “*” in an object may denote any character, string or symbol. Any categories, e.g., as defined by a user or requested by interested parties such as publishers or advertisers may be defined and any object may be associated with any one or more classes, categories, or other classifying parameters. As exemplified by the “*” above, any rules may be employed for classifying objects, thus automatic, generic, or other classification methods may be employed in order to enable a system or method to classify any object. For example, a default classification may exist, or a classification based on a geographical location, time of day, or other parameters may all be employed by the disclosed embodiments.

According to the disclosed embodiments, a URL or a prefix of a URL may be associated with a number of classifying parameters as described herein. Classifying a URL or a prefix as described herein may include associating the URL (or prefix) with a number of classification parameters which may be based on or according to various aspects. For example, a URL, URL prefix, web site, or webpage may be associated with a number of classifying parameters that may be related to a number of aspects. Accordingly, a prefix in the prefix lookup 225 may be classified according to a gender, a geographic parameter, an income related parameter, a weather parameter or any other parameter that may be applicable, e.g., to an advertising in a related webpage. For example, it may be determined that a specific webpage is typically requested or downloaded by web surfers of a specific socio-economical group. For example, the probability that a webpage is requested or downloaded by surfers associated with a range of predefined occupations, incomes, number of children, or geographical locations may be known. Likewise, a gender may be associated with webpages, web sites, etc. For example, it may be determined or known that the majority of downloads from a known web site are performed by females and/or by females of a known age range (e.g., teenage girls).

Information relating or associating webpages, web sites, and so on with aspects such as gender, geographic location, income, etc., may be obtained from any source as known in the art, e.g., surveys, statistics, content analysis of webpages, information provided (possibly anonymously) by users, and so on. Such sources may be external to the classifier 150. For example, manual entries as described herein may include entries reflecting gender, income, geographic parameters, etc. Other parameters may be automatically obtained. For example, as known in the art, internet protocol (IP) addresses may be allocated based on geographical parameters (e.g., a part of an IP address may indicate a country). Accordingly, geographical aspects related to requests may be obtained from protocol headers and an association of a web site or webpage with a specific geographical area may be made. Complex associations may be made in a classification of web sites or pages. For example, by observing weather reports and correlating them with requests received by web sites, an association of weather conditions with a web site or page may be made. For example, it may be determined that a specific webpage's popularity is related to weather (e.g., a site where coats are sold may gain popularity during a rainy season). It will be understood that the above correlation or association of web sites or pages with various aspects are exemplary ones and that any aspect may likewise be associated with a webpage, a URL or a URL prefix. In some embodiments, privacy issues may be observed. For example, information associating web pages or URLs with aspects as described herein may be statistical and anonymous such that the privacy of users or surfers is not jeopardized.

Accordingly, the classifier 150 may classify a URL, webpage, web site, or a URL prefix with one or more classification parameters that may be related to one or more aspects. For example, the prefix lookup 150 may include multi-level classification of URL prefixes. A plurality of classification parameters may be provided as described herein. For example, the prefix lookup 225 may include a number of classifications for a given URL prefix and all or some of such classification parameters may be provided as described herein.

An automated procedure may be implemented to translate or transform information from external sources described herein such as those in the third party unit 235, the manual entries 240 and/or the statistical data 245 to a format and/or taxonomy of the prefix lookup 225. For example, classification information in external sources may be converted, modified, or otherwise manipulated or processed and inserted into the prefix lookup unit 225. Accordingly, the prefix lookup unit 225 may include classification information based on any applicable external or internal source.

The manual entries unit 240 may store manual entries. For example, an employee may manually enter records comprising a classified object (e.g., one or more URL's prefixes, a site, a URL, a part of a URL, a domain, or a subdomain) and a classification parameter associated with the classified object based on specific instructions. For example, a set of URLs or sites may be associated with a respective set of classification parameters and the employee may manually create records in the manual entries 240 according to such sets. Additionally or alternatively, a user may identify unclassified objects, e.g., sites, domains, or subdomains for which no classification exists in the system (e.g., in the prefix lookup 225) but, in addition, requests for advertisements for these sites or domains as described herein are seen or recorded. Such unclassified yet relevant sites, URLs, domains, or subdomains may be manually added to the manual entries 240. Such manual process may lead, with a feasible effort, to an ever increasing, high-accuracy coverage of URLs.

The third party information module 235 and the manual entries unit 240 may be used to construct an initial table or repository and further used to increase coverage of classified objects, but may not be suitable for maintaining a large database. For example, the number of relevant web sites and/or pages may be too large for a method of manually entering web sites or pages into a list or repository. In addition, sites (or content therein) typically change over time. Thus, an entry made today may be irrelevant tomorrow, furthermore, new web sites and/or pages are added on a daily or even hourly basis. Such aspects as well as other aspects may be dealt with by the statistical data unit 245.

The statistical data unit 245 may be used to evaluate, refine, update or otherwise process information in, or used by, the classifier 150. For example, statistical data unit 245 may be used to refine or otherwise modify data in, or add data to, prefix lookup 225. In some embodiments, statistical information related to webpages, web sites, and so on may be collected and examined. In addition, other methods such as “machine learning” can be used for proper prefix classification. For example, prefix lookup 225 may contain the prefix “nbc.com” that may be classified as “American news”. Accordingly, a request that is associated with a URL containing the exemplary prefixes “http://www.nbc.com/travel/restaurants/index.htm”, “http://www.nbc.com/travel/bike/index.htm”, and “http://www.nbc.com/travel/hiking/index.htm”, respectively, may all be classified as “American news”. Statistical or other algorithmic examination may discover that a large number of requests associated with the prefix “nbc.com” also contain travel. Otherwise put, statistical analysis may determine that the prefix “nbc.com/travel” appears a substantial number of times and/or that when “nbc.com” is seen the probability that “nbc.com/travel” will be observed is at least a predefined value or probability. Accordingly, it may be determined that the prefix “nbc.com/travel” merits its own classification. In such a case, semantic analysis of the prefix “nbc.com/travel” may be performed and this prefix may be associated with a classification, e.g., a “travel”, “trips”, “sightseeing” or other classification that may be more suitable.

As further described herein, the statistical data 245 may alternatively or additionally be modified by the deep semantic classification unit 230. The statistical calculations or aspects may further cause removal of classifications from the prefix lookup 225 and/or the cache 215. For example, it may be statistically determined that a specific prefix has not been observed for a predefined period of time or a predefined number of requests and accordingly, such prefix and associated classification may be removed from the cache 215 and/or the prefix lookup 225. It will be understood that any statistical analysis, algorithms, observations and/or units may be used in order to modify lookup tables or caches such as the cache 215 and the prefix lookup 225.

Although not shown, the classifier 150 may include, be operatively connected to, or otherwise associated with any pre-processing component or unit that may process, and possibly modify, a URL prior to the URL being provided to, and processed by, the classifier 150. For example, a component that may strip any redundant, irrelevant, or other information from a URL may process a URL associated with a request for an advertisement and provide a processed URL to the classifier 150. Likewise, such processing may be performed between units in the classifier 150. For example, a URL provided to the deep semantic classification unit 230 may be processed as described herein after being classified by the deep semantic classification unit 230, but before being provided to the cache 215. Processing a URL as described herein may comprise transforming a URL to a canonical form which may be according to a form best suited for processing by the cache 215. Accordingly, a preprocessor may receive a URL, transform it to a canonical form and provide the transformed URL to the classifier 150.

As described herein, preprocessing a URL may comprise removing redundant information. For example, a URL received by the classifier 150 may be in the form of “http://www.nbc.com/news?article=121 &sessionid=343248” in which “article” points to a specific article which may be relevant to the classification. However, “sessionid”, may be a protocol parameter which may be unrelated to the actual webpage, website or domain, or otherwise irrelevant to a classification of the URL. Accordingly, a preprocessor may transform the above exemplary URL into a new URL, “http://www.nbc.com/news?article=121”, and may provide such transformed or preprocessed URL to the classifier 150. Any preprocessing, transformation or manipulation may be performed on a URL either before it is being provided to the classifier 150 or between a processing by a first and second units within the classifier 150.

As described herein, the cache 215 may be any caching system, device, or unit and may include hardware, software, firmware, or any combination thereof. The cache unit 215 may generally store a set of requests and respective classification. The cache 215 may be capable of providing a classification for a request (based on a previously determined classification) very fast. However, the cache 215 may be limited to a number of entries that may not suffice for all requests that may be received by the classifier 150. In some embodiments, if the cache 215 fails to provide a classification for a request, the requests may be provided to the URL splitting unit 220.

The URL splitting unit 220 may split or parse a URL into two or more parts or terms, may semantically analyze such two or more parts of a URL and may associate a classification with the URL based on the semantic analysis. For example, a prefix of a URL of the form http://www.israelweather.co.il may be determined to be “israelweather”, and such prefix may be split into “israel weather” and the terms “israel” and “weather” may be semantically analyzed. An analysis result may be used to associate a classification with the prefix, for example, a result of semantic analysis of the above URL may be used to associate the prefix “israelweather” with a category or class that may be “weather”, “weather in israel”, etc.

Various algorithms or techniques may be employed by the URL splitting unit 220 when splitting and analyzing parts of a URL. For example, a prefix of a URL of the form “http://www.watchsmallvilleonline” may be split into either “watchs mall vi (1) leon line” or into “watch smallville online”. Accordingly, an algorithm that may best split a URL's prefix may be used. In some embodiments, after splitting a URL and semantically analyzing the parts resulting from such splitting, the analysis results and/or a classification made based on the results may be compared or otherwise related to known results or classifications in order to assess their relevance.

In a case where it may be determined that an analysis result or a resulting classification is unlikely to be relevant (e.g., similar classifications do not exist) the URL prefix may be split differently and the analysis and classification process may be repeated. Generally, splitting a URL and analysis of the resulting parts may comprise splitting the URL and determining if the resulting parts, terms, or strings are known terms. In one embodiment, various characters may be identified as separating symbols. For example, in a URL containing the string “how-far-is-the-moon.html” the “-” character may be identified as a separator and, accordingly, splitting such URL may result in the terms “how”, “far”, “is”, “the”, “moon”. As exemplified, some terms or strings may be ignored. For example, the term “html” may be a known term and may be ignored in the process of splitting and/or analyzing a URL as described herein.

In some embodiments, splitting a URL may comprise only splitting the domain and subdomain names in the URL. Probabilistic methods to decide the most plausible split may be employed. For example, existence of terms resulting from splitting a URL in a predefined dictionary may determine the most relevant split. For example, a URL containing the term “usnavy.com” may be split into “us”, “navy” and/or “usn”, “avy”. Based on a determination that both the terms “us”, and “navy” are found in a dictionary but none of the terms “usn” and “avy” are found in such dictionary, the first set may be chosen for analysis. Another example may be “supermanager.com” that may be split into “super” and “manager” or “superman” and “ager”. In this case, the first set may have two terms found in a dictionary while the second set may only have one such term, accordingly, the split yielding more known terms (e.g., the first in the above example) may be chosen for analysis. Various other rules, criteria or constraints may govern splitting of URLs. For example, a split that yields longer terms may be chosen, e.g., a split yielding “dandelion” may be preferred over one that yields “dan”, “de”, and “lion”. Splitting a URL may be based on the analysis result of resulting terms. For example, after splitting a URL and semantically analyzing the resulting terms, a score (e.g., a confidence level) may be computed for, and associated with, the result. Next, a different splitting may be attempted and the semantic analysis may be repeated. Next, the confidence levels or other scores associated with the analyses may be compared and the split associated with the highest score may be chosen.

In some embodiments, a classification of a URL performed by splitting as described above may be performed and the classification (or a parameter related to the classification) may be provided to a client as described herein. In other embodiments, a classification of a URL prefix produced by the URL splitting unit 220 and an associated prefix may be provided to the prefix lookup unit 225. Other sources providing input to the prefix lookup unit 225 may be the third party information unit 235, the manual entry module or repository 240 and the statistical data unit 245 as described herein.

The URL prefix lookup unit 225 may contain or access a set of URL prefixes and associated classifications. As known in the art, a URL typically contains a domain or domain name, a sub domain or path, and a file or page name or reference. A subdomain may be or may include the domain and any part of a path, excluding the file or resource name. As an example, in the URL “http://www.suntimes.com/entertainment/music/classical/1975430.html” the domain may be “www.suntimes.com”, and “www.suntimes.com/entertainment/”, “www.suntimes.com/entertainment/music/” and “www.suntimes.com/entertainment/music/classical/” may be possible subdomains.

Typically, websites are arranged in a hierarchy, and in many cases, such hierarchy is reflected in the websites' URLs. For example, in the exemplary “http://www.suntimes.com/entertainment/music/classical/1975430.html” URL, it may be determined that the webpage or resource referenced by “1975430.html” is related to classical music. Accordingly, URL prefix lookup unit 225 may store (e.g., in a table, a list, or another construct) a list of URL prefixes and an associated class, category, or related parameter. Thus, an accurate classification of URLs may be performed, including different classifications of different URLs provided by the same website. For example, a first URL prefix of the form “www.suntimes.com/entertainment/music/” may be classified or categorized as “music” and another, second URL prefix associated with the same website having the form of “www.suntimes.com/entertainment/books/” may be classified or categorized as “literature”. As described herein, possibly if no classification for a URL may be determined by the URL splitting unit 220, then the prefix lookup unit 225 may examine any prefix of the URL, locate the prefix in a lookup table, and return a classification of the URL as recorded in the lookup table. Any URL prefix may be stored in a lookup table in association with a categorizing or classification or a classification parameter.

For example, both the prefixes “www.suntimes.com/entertainment/” and “www.suntimes.com/entertainment/music/” may be stored and each may be associated with a different classification. Accordingly, an accuracy or granularity of a classification may be enhanced as a website expands by providing additional classifications for sections of a website that may be automatically added to the classifier 150 as described herein. As described herein, the prefix lookup unit 225 or information therein may be updated or modified by any one of the third party information repository unit 235, the manual entry module or repository 240, or the statistical data unit 245. For example, analysis of information in the third party information unit 235 may produce an association of a set of URLs or prefixes of URLs with respective categories. Such prefixes and associated categories may be provided to, and stored by, the URL prefix lookup unit 225, and may further be used as described herein.

The deep semantic classification unit 230 may be activated in a number of modes or circumstances. The deep semantic analysis may be utilized to determine categories based on content in a web page upon receiving an advertisement to provide finer granularity for determining whether the web page has negative content for the advertisement. The deep semantic analysis performed by the classification unit 230 may be any analysis of any information related to a resource. For example, deep semantic analysis performed by the deep semantic classification unit 230 may include using a provided URL to obtain the related webpage and semantically analyzing the webpage's content and or any content or information related to the webpage.

Semantic analysis of content in a webpage may be performed using any algorithm, method, or means, e.g., as known in the art. For example, text analysis may be performed on text in a webpage and image analysis may be performed on images in a webpage. Further, analysis of the content in a web page may include determining a number of advertisements to be displayed in the web page. Metadata related to a webpage may also be analyzed or taken into account. For example, the language used, the font used, etc., may all be analyzed and used for categorizing a webpage by the deep semantic classification unit 230. Although processing a webpage by the deep semantic classification unit 230 as described herein may be relatively slow, a very accurate classification of webpages may be made possible by the deep semantic classification unit 230, e.g., based on semantic or other analysis of content in the webpage.

It should be noted that the particular architecture described herein above with respect to FIG. 2 is merely exemplary and does not limit the disclosed embodiments. Different modules, units, and/or repositories may be utilized in conjunction with the classifier 150 without departing from the scope of the disclosure.

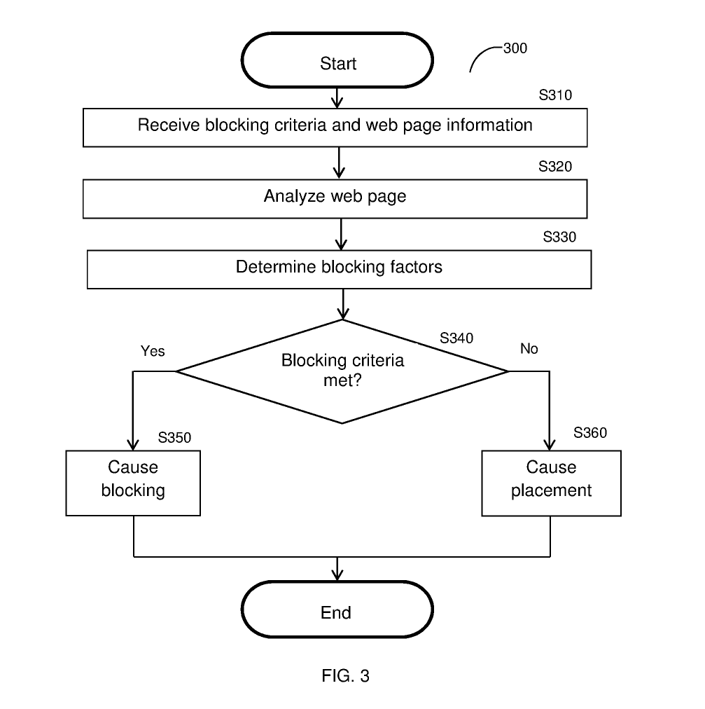

FIG. 3 is an exemplary and non-limiting flowchart 300 illustrating a method for criteria-based advertisement blocking according to an embodiment. In an embodiment, the method may be performed by a reputation service module (e.g., the reputation service module 160). In a further embodiment, the reputation service module 160 may cause the blocking and/or placement of advertisements via an advertisement serving module (e.g., the advertisement serving module 170).

At S310, blocking criteria and information identifying the web page are received. The identifying information may include, but is not limited to, a URL, content in the web page (e.g., text, audio, videos, images, etc.), and so on. The blocking criteria may include, but is not limited to, categories defined as negative content for the advertisement, a tolerance score threshold of the advertisement, a threshold quantity of advertisements in a web page, a language of the advertisement, and so on. The tolerance score threshold indicates a minimum acceptable tolerance score for each category and/or for each advertiser of the advertisement to be displayed.

At S320, the web page information is analyzed. The analysis may include, but is not limited to, a semantic analysis of the content in the web page, an analysis of a domain of the URL of the web page, a textual analysis of the URL of the web page, and so on. Semantic, domain, and URL analyses are described further herein above with respect to FIG. 2. In an embodiment, the analysis may only include analyzing a URL string of the web page. In a further embodiment, the domain and/or the URL of the web page may only be analyzed if no content in the web page is available.

At S330, based on the analysis, one or more blocking factors associated with the web page may be determined. As an example, if a semantic analysis of images in the web page demonstrates that the web page features images of damaged houses and large amounts of water, the determined categories may include “disaster,” “hurricane,” and/or “water damage.”

The blocking factors may include, but are not limited to, categories of content in the web page, advertiser preferences of the web page, quality information, and so on. The quality information may include, but is not limited to, a number of advertisements to be displayed in the web page, a language of the web page, and so on. The advertiser preferences may indicate, e.g., preferred advertisers, disfavored advertisers, and so on. The advertiser preferences may further indicate a degree of preference and/or disfavor. The degree may be represented as, e.g., a positive (preferred) or negative (disfavored) value. As an example, for degrees on a scale of −10 (highly disfavored) to +10 (highly preferred), an advertiser known for highly inappropriate content may be assigned a preference degree of −10.

In an embodiment, S330 may further include generating a tolerance score based on the blocking factors. Each tolerance score indicates a tolerance of the web page respective of various categories or advertisers of advertising content. The tolerance scores may be generated based on, e.g., the determined categories (e.g., a web page featuring terror content may be highly tolerant to advertisements related to terror), similarities among categories (e.g., a web page including skateboard content may be more tolerant to roller blade advertisements than a web page including stock market content), advertiser preferences and/or preference degrees (e.g., an advertiser that is indicated as a reliable source of appropriate advertisements may be assigned a higher tolerance score than an advertiser that is known to provide offensive or otherwise inappropriate content), similarities between the advertiser and content of the web page (e.g., a web page featuring content related to business may be more tolerant to advertisers associated with office supplies than for advertisers associated with sporting goods), and so on. In a further embodiment, the tolerance scores may be aggregated into a joint tolerance score for the advertisement. The aggregation may be further based on weighted values for each tolerance score. For example, the category “mature” may be associated with a higher weight than the category “food” because the category “mature” is more likely to be inappropriate in a particular web page.

At S340, it is determined whether the blocking criteria have been met and, if so, execution continues with S350; otherwise, execution continues with S360. In an embodiment, the blocking criteria may be met if one or more of the determined categories is defined by the blocking criteria as associated with negative content for the advertisement. In another embodiment, the blocking criteria may be met if one or more of the determined tolerance scores and/or the joint tolerance score is below the tolerance score threshold. In another embodiment, the blocking criteria may be met if the number of advertisements in the web page is above the threshold advertisement quantity. In yet another embodiment, the blocking criteria may be met if the language of the advertisement does not match the language of the web page.

At S350, upon determining that the blocking criteria have been met, the advertisement is blocked, thereby preventing its display in the web page. Blocking the advertisement may include, but is not limited to, causing an advertisement serving system to not place the advertisement in the web page, sending a re-direct request, and/or displaying an error message. In an embodiment, S350 may further include causing an advertisement serving module to place a default advertisement for display in the web page. The default advertisement may be, for example, an advertisement that is typically effective regardless of the subject matter of the web page. In another embodiment, the blocking of an advertisement may trigger a request for placing a new advertisement.

In another embodiment, S350 may further include causing a redistribution of the blocked advertisement. Redistributing the blocked advertisement may include, but is not limited to, passing an impression of the advertisement back to a publisher server for display of the advertisement in a different web page. As an example, an advertisement including mature content may be blocked from being displayed in a web page featuring children's toys content, and its impression may be sent back to a publisher server to indicate that the advertisement should be redistributed. The redistributed web page may subsequently be displayed in a web page featuring mature or otherwise similar content.

At S360, upon determining that the blocking criteria have not been met, placement of the advertisement in the web page is caused. The placement may be caused via, e.g., an advertisement serving system.

As a non-limiting example, blocking criteria for a toy advertisement and text in a web page are received. The blocking criteria indicate that web pages categorized as related to drugs should be blocked as including negative content. The text in the web page is semantically analyzed, thereby identifying several words such as “snort,” “cocaine,” and “crack.” Based on the semantic analysis, categories of the web page are determined to be “illegal substances,” “cocaine,” and “drugs.” Accordingly, it is determined that the blocking criteria have been met and the advertisement is blocked. Placement of a default advertisement as well as redistribution of the advertisement is caused. The redistributed advertisement is subsequently placed in a web page featuring video of a children's cartoon.

As another non-limiting example, blocking criteria for a horror advertisement and a video in a web page are received. The blocking criteria indicate a tolerance score threshold of 80%, i.e., that the advertisement should be blocked in web pages having a tolerance score of less than 80% for horror content. The video in the web page is semantically analyzed to determine that categories of the web page include “scary movie,” “violence,” “monsters,” and “horror.” Based on the analysis, it is determined that the web page has a tolerance score of 95% for horror advertisements. Accordingly, it is determined that the blocking criteria have not been met, and placement of the advertisement in the web page is caused.

As yet another non-limiting example, blocking criteria for an advertisement and content in a web page are received. The blocking criteria indicates an advertisement quantity threshold of at least 5 advertisements. The content of the web page is semantically analyzed to determine that the web page will display 6 advertisements at a time. Based on the analysis, it is determined that the blocking criteria have been met, and placement of the advertisement in the web page is blocked.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for criteria-based advertisement blocking, comprising:
receiving blocking criteria of an advertisement to be displayed in a web page and information identifying the web page;
analyzing the identifying information to determine at least one blocking factor associated with the web page, wherein the identifying information includes at least a uniform resource locator (URL) of the web page;
determining, based on the at least one blocking factor, whether the blocking criteria have been met; and
automatically blocking a display of the advertisement in the web page, when the blocking criteria have been met.

2. The method of claim 1, wherein each blocking factor is at least one of: a category of content in the web page, an advertiser preference associated with the web page, a number of advertisements to be displayed in the web page, and a language of the web page.

3. The method of claim 2, wherein the blocking criteria includes at least one of: a list of negative categories for the advertisement, a tolerance score threshold, an advertisement quantity threshold, and a language of the advertisement.

4. The method of claim 3, further comprising:
generating at least one tolerance score based on the at least one blocking factor; and
comparing the tolerance score threshold to the generated at least one tolerance score, wherein the blocking criteria have been met when any of the at least one tolerance score is below the tolerance score threshold.

5. The method of claim 3, wherein the blocking criteria have been met when the number of advertisements to be displayed in the web page is above the advertisement quantity threshold.

6. The method of claim 3, wherein the blocking criteria have been met when the language of the web page is different from the language of the advertisement.

7. The method of claim 1, wherein the identifying information includes a content of the web page analyzing the identifying information further comprises:
semantically analyzing the content in the web page, wherein the at least one blocking factor is determined based on the results of the semantic analysis.

8. The method of claim 1, wherein the at least one blocking factor is determined based on the results of the uniform resource locator analysis.

9. The method of claim 1, wherein the identifying information includes a domain name, and wherein analyzing the identifying information further comprises:
analyzing the domain of the web page, wherein the at least one blocking factor is determined based on the results of the domain analysis.

10. The method of claim 1, further comprising:
sending the advertisement for redistribution, when the blocking criteria have been met.

11. A non-transitory computer readable medium having stored thereon instructions for causing one or more processing units to execute the method according to claim 1.

12. A system for criteria-based advertisement blocking, comprising:
a processing unit; and
a memory, the memory containing instructions that, when executed by the processing unit, configure the system to:
receive blocking criteria of an advertisement to be displayed in a web page and information identifying the web page;
analyze the identifying information to determine at least one blocking factor associated with the web page, wherein the identifying information includes at least a uniform resource locator (URL) of the web page;
determine, based on the at least one blocking factor, whether the blocking criteria have been met; and
automatically block a display of the advertisement in the web page, when the blocking criteria have been met.

13. The system of claim 12, wherein each blocking factor is at least one of: a category of content in the web page, an advertiser preference associated with the web page, a number of advertisements to be displayed in the web page, and a language of the web page.

14. The system of claim 12, wherein the blocking criteria includes at least one of: a list of negative categories for the advertisement, a tolerance score threshold, an advertisement quantity threshold, and a language of the advertisement.

15. The system of claim 14, wherein the system is further configured to:
generate at least one tolerance score based on the at least one blocking factor; and
compare the tolerance score threshold to the generated at least one tolerance score, wherein the blocking criteria have been met when any of the at least one tolerance score is below the tolerance score threshold.

16. The system of claim 14, wherein the blocking criteria have been met when the number of advertisements to be displayed in the web page is above the advertisement quantity threshold.

17. The system of claim 14, wherein the blocking criteria have been met when the language of the web page is different from the language of the advertisement.

18. The system of claim 13, wherein the system is further configured to:
semantically analyze content in the web page, wherein the at least one blocking factor is determined based on the results of the semantic analysis.

19. The system of claim 13, wherein the at least one blocking factor is determined based on the results of the uniform resource locator analysis.

20. The system of claim 12, wherein the identifying information is a domain name, and wherein the system is further configured to:
analyze the domain name of the URL, wherein the at least one blocking factor is determined based on the results of the domain analysis.

21. The system of claim 12, wherein the system is further configured to:
send the advertisement for redistribution, when the blocking criteria have been met.
